(19) United States
(12) Patent Application Publication
(10) Pub. No.: US 2007/0233712 A1
(43) Pub. Date: Oct. 4, 2007

(54) CHECKLIST MANAGEMENT DEVICE, CHECKLIST MANAGEMENT METHOD, AND RECORDING MEDIUM THEREFOR

(75) Inventors: Jun Arima, Kawasaki (JP); Fumiyoshi Sasagawa, Kawasaki (JP); Terunobu Kume, Kawasaki (JP); Takahiro Saito, Kawasaki (JP); Akira Kawamura, Kawasaki (JP); Hiromi Kusumoto, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/425,795

(22) Filed: Jun. 22, 2006

(30) Foreign Application Priority Data
Mar. 29, 2006 (JP) 2006-092499

(51) Int. Cl. G06F 7/00

(52) U.S. Cl. 707/100

(57) ABSTRACT

A recording medium causing computer to execute a checklist management program for managing a checklist comprised of a plurality of operation items to be checked, which generates attribute information specifying if the operation item is conducted for each of the operation items, obtains frequency distribution about an evaluation value corresponding to the generated attribute information based on a relationship which is prepared between the attribute information and the evaluation value, and sets an evaluation degree corresponding to the generated attribute information based on a frequency corresponding to an evaluation value that is equal to or greater than a prescribed threshold value in the frequency distribution. The generated attribute information comprises first attribute information obtained by setting t one of the operation items, which are not conducted among input attribute information, to be conducted. An evaluation degree obtained for the first attribute information is set as a priority.

### BACKGROUND OF THE INVENTION

1. Field of the Invention

The present invention relates to a checklist management device which can hold information about if the contents of check items included in a checklist are conducted or not conducted.

2. Description of the Related Art

Techniques are used in respective businesses where operations are listed that will be conducted, and a computer is used to manage the checklist to confirm if the operations are conducted or not. By employing the checklist to execute the business, it is possible to confirm operation items that are more important than others for, e.g., higher quality without omission even in an operation including a large number of operation items.

As a technique for using the computer to manage the checklist, a technique is supposed that surely and smoothly progresses procedures for solving problems. The system stores information of contents or the like of countermeasure of the proposed problem when a failure occurs in a database, and confirms the countermeasure states about the problem (Patent Document 1 for example). Also, another technique for effectively utilizing the checklist for the business uses evaluation item information and check result information for each check item which are recorded. An evaluation coefficient is calculated for each item based on the check result information and an overall evaluation coefficient is calculated based on the evaluation coefficient of the respective items (Patent Document 2 for example). Further, a technique is also provided in which a user assigns to operations priorities based on a reference value or the like which is registered in advance, and operations which should be conducted with priorities can be output (Patent Document 3 for example).

Patent Document 1
Japanese Patent Application Publication No. 2003-187069

Patent Document 2
Japanese Patent Application Publication No. 2003-312454

Patent Document 3
Japanese Patent Application Publication No. 2000-56961

The number of the check items managed in the checklist tends to increase increasingly and it is probable that an operator omits checking an important item with an increased check items. When an objective index is provided for specifying items by conducting whose operations an effect can be attained, it is possible to enhance efficiency of operations in the checklist. Also, for a person responsible for maintenance of management of the check items in the checklist, it is desired, in view of reduction of load of the maintenance, that important items remain in the list and items which are thought to have relatively lower importance can be deleted from the list.

### SUMMARY OF THE INVENTION

An object of the present invention is to provide a technique in which user convenience is enhanced by providing information that has availability for each checklist user of the.

In order to attain the above object, the present invention provides a recording medium causing a computer to execute a checklist management program to manage a checklist including a plurality of operation items that are to be checked, comprising generating attribute information specifying if the operation item is conducted for each of the operation items, obtaining frequency distribution about an evaluation value corresponding to the generated attribute information based on a relationship which is prepared beforehand between the attribute information and the evaluation value corresponding to the attribute information, and setting an evaluation degree corresponding to the generated attribute information based on a frequency corresponding to an evaluation value that is equal to or greater than a prescribed threshold value in the frequency distribution. The generated attribute information is comprised of first attribute information obtained by setting one of the operation items, which are not conducted among input attribute information, to be conducted. Additionally, an evaluation degree obtained for the first attribute information is set as a priority specifying a degree with which the operation item which is not conducted should be conducted preferentially.

When information (attribute information) specifying if each operation item (items to be checked) is conducted is input into to the checklist management device, the first attribute information, in a case if one of the operation items which are not conducted is set to be conducted, is generated. Then, a priority is obtained based on a frequency at which an evaluation value larger than a prescribed threshold value can be obtained from the evaluation value's frequency distribution about the first attribute information. Because the frequency distribution about the evaluation value corresponding to the first attribute information is obtained from the relationship which is beforehand prepared between the attribute information and the evaluation value, the priority obtained thereby is presented to a user as an objective index specifying operation items which should be conducted preferentially.

It is possible that the priority is obtained for each of the operation items which are not conducted. The priorities are output and displayed regarding a prescribed number of the operation items, which are not conducted, in order from the highest priority to the lowest. The orders of the operation items with high priorities are displayed on the checklist. This is more convenient for the user.

Further, it is possible that the evaluation degree obtained for the input attribute information is set as the success degree specifying a degree that the operation succeeds. The user of the checklist can perform operations by referring to the success degree, which is objectively determined at the time the attribute information is input.

Further, it is possible that one of the plurality of the operation items is selected as a selected operation item, the second attribute information is generated by using a setting that only the selected operation item is conducted and other operation items are not conducted, and the evaluation degree obtained for the second attribute information is set as influence specifying a degree that the selected operation item contributes to a success of an operation. The operation items with smaller influences to the result in the checklist are displayed. Thus, the person responsible for checklist maintenance can use the displayed items as an objective index when deleting unnecessary operation items, for example.

The relationship which is previously prepared between the attribute information and the evaluation value is obtained by increasingly accumulating the attribute information and the evaluation values corresponding to the attribute information each time the checklist is used, and learning the extent of the relationship between the attribute information and the evaluation value corresponding to the attribute information, which are accumulated. The above learning is performed by a learning machine such as a support vector machine or the like for example.

Additionally, the scope of the present invention is not limited to the recording medium or the program which is stored in the above recording medium and executed by a computer. The scope of the present invention includes a checklist management device and a checklist management method, which employ the above program.

According to the present invention, it is possible to present objective information to the checklist user. Accordingly, it is more convenient when the user uses the checklist.

### BRIEF DESCRIPTION OF THE DRAWINGS

FIG. 1 shows a configuration of a checklist management device;

FIG. 2 shows an example of a user interface of the checklist management device;

FIG. 3 shows another example of the user interface of the checklist management device;

FIG. 4 shows still another example of the user interface of the checklist management device;

FIG. 5 is a flowchart showing basic operations of the checklist management device;

FIG. 6 shows data stored in an attribute result accumulation unit;

FIG. 7 is a flowchart showing processes of obtaining a certainty distribution;

FIG. 8 is a flowchart showing processes of obtaining a priority;

FIG. 9 is a flowchart showing processes of obtaining an influence;

FIG. 10 shows a configuration of an information processing device; and

FIG. 11 shows recording medium.

### DESCRIPTION OF THE PREFERRED EMBODIMENT

Listed below are preferred embodiments of the present invention, which are explained in detail by referring to the drawings.

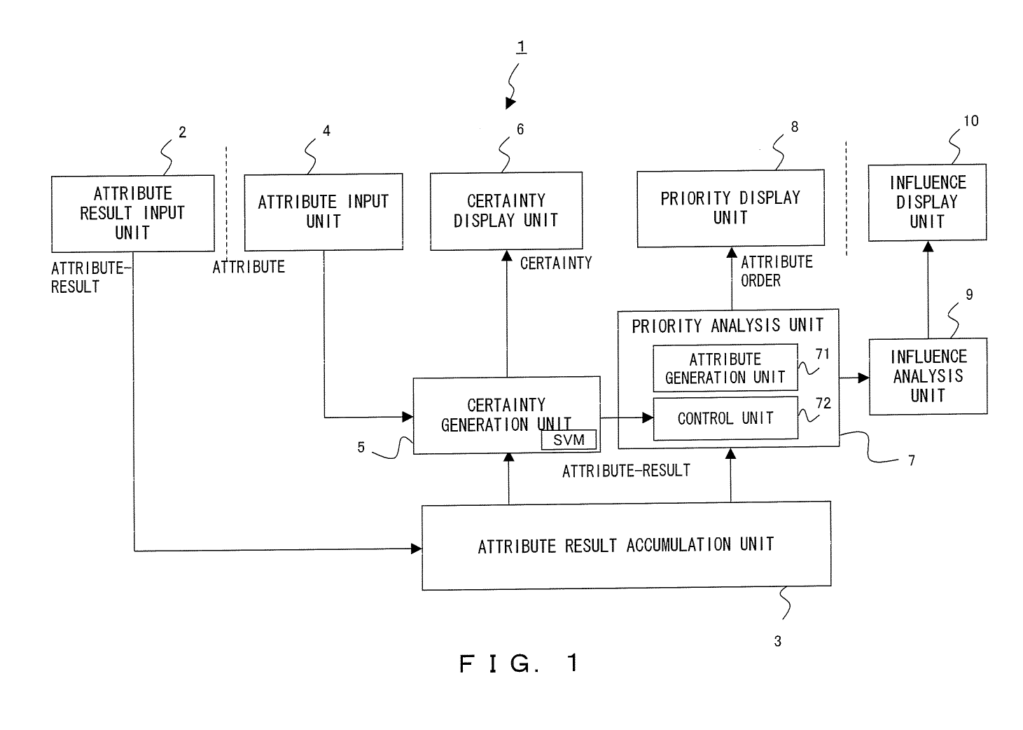

FIG. 1 shows a checklist management device configuration according to the present embodiment. The checklist managed in a checklist management device 1 of FIG. 1 employs a configuration in which the operations to be conducted are displayed in a list. It is possible to confirm whether or not the operations in the checklist are conducted for each operation, i.e., fore a check item. A user of the checklist accesses the checklist management device 1 via the user's terminal or the like and inputs the conduct states of the operations in the checklist corresponding to a use ID for recognizing the checklist assigned to each user. In the explanation of the embodiment below, information specifying the conduct state is referred to as an operation attribute (attribute). The “use ID for recognizing the checklist assigned to each user” is used to mean that the use ID is assigned to each user of the checklist and is also assigned to each case of use of the checklist, and that the above respective checklists are discriminated from one another. In other words, for example, when a checklist is used which is prepared for checking the steps of software development, different use IDs are separately assigned not only to one project team and another project team using the checklist, but also to one and the same team using the checklist in one development step and in the next development step.

The checklist management device 1 manages the plurality of checklists. However, in the explanation below, an explanation is given for a method in which respective information about one of the plurality of the checklists managed are output to the user of the checklist.

The checklist management device 1 of FIG. 1 is comprised of an attribute result input unit 2, an attribute result accumulation unit 3, an attribute input unit 4, a certainty generation unit 5, a certainty display unit 6, a priority analysis unit 7, a priority display unit 8, an influence analysis unit 9, and an influence display unit 10.

The attribute result input unit 2 inputs past data to the checklist management device 1. The past data is data in which information about the operation attribute. The result and evaluation of the operation is stored in the checklist to which one use ID is assigned. The attribute result accumulation unit 3 accumulates the past data input. The attribute input unit 4 inputs the attribute which is information specifying whether the operations are conducted or not conducted for each check item included in the checklist.

The certainty generation unit 5 obtains the certainty distribution of the operation specified by the data newly input via the attribute input unit 4 based on the past data accumulated in the attribute result accumulation unit 3. The certainty generation unit 5 includes Support Vector Machine and the like, and the detail thereof will be explained later. The certainty display unit 6 outputs and displays the certainty distribution obtained as the result of the process in the certainty generation unit 5. The certainty is the probability about which evaluation is given in accordance with the attribute input from the attribute input unit 4 in the case that the result and evaluation of the operation is expressed in five grades of evaluation, for example.

The priority analysis unit 7 analyzes the attribute input via the attribute input unit 4, i.e., analyzes which item is the item by conducting which the evaluation is improved if conducted although the item is a not conducted item according to the input information. The priority analysis unit 7 includes an attribute generation unit 71 and a control unit 72. The attribute generation unit 71 generates various attributes by overwriting values of the input attributes in order to obtain various information to be output to the user. The control unit 72 controls processes of the attribute generation unit 71 and the like. A priority display unit 8 outputs and displays the result of the analysis of the priority analysis unit 7.

The influence analysis unit 9 analyzes how much the conduct of check items contributes to the improvement of the evaluation for each check item in the checklist. The influence display unit 10 outputs and displays the analysis result of the influence analysis unit 9.

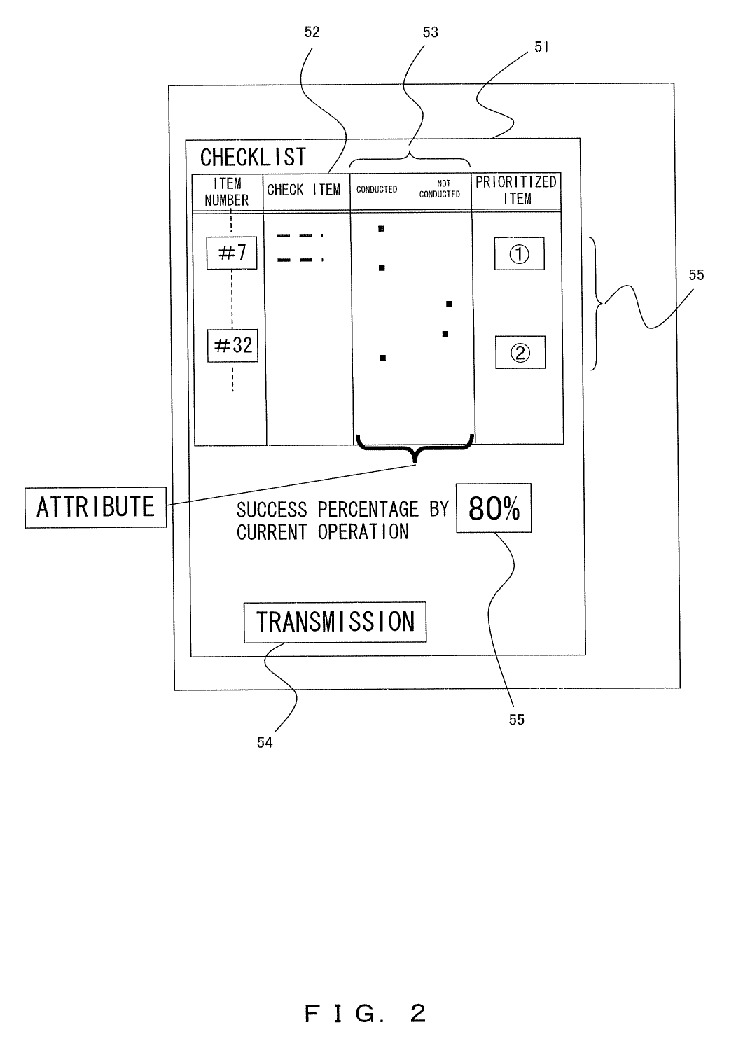

FIG. 2 shows an example of a user interface of the checklist management device 1 according to the present embodiment. The window in FIG. 2 is an example of a window displayed for an operator or the like who uses the checklist for managing the progress of an operation. When a user's name, the above use ID, and the like are input to the checklist management device 1, they are displayed.

As shown in FIG. 2, item numbers are assigned to check items 52 specifying details of operations. As for conduct state information 53 corresponding to the check items 52, it is possible to select if the items are conducted for each item by using radio buttons for example.

When a transmission button 54 located in a lower portion of the window is pressed by the operator who has input the conduct state information 53 regarding the respective check items 52, the information about the operation attribute of the checklist is transmitted to the checklist management device 1. When receiving the operation attribute information in the attribute input unit 4, the checklist management device 1 displays a success percentage calculated based on the input operation attribute in a success percentage output section 55. Also, as prioritized item information 51, which is the rightmost in the list, the items by conducting which the probability of success of the business in the checklist becomes higher are displayed as the items to be conducted with priorities together with the priority order thereof among the items which are not conducted.

Here, the success percentage displayed in the success percentage output section 55 is the probability that the evaluation is equal to or greater than a prescribed threshold value when the operation attribute is provided when the transmission button 54 is pressed based on the accumulation of past data. The success percentage is calculated using the certainty distribution described in the explanation of FIG. 1. In the embodiment, the certainty is set such that the sum of the probabilities of obtaining the respective evaluations in five grades is one hundred.

For example, “3” is set as the prescribed threshold value for determining if the operation was successful. That is, when an evaluation of three or higher in the five grades is obtained, it is determined that the operation is successful. Then, if the certainty distribution is [5, 15, 70, 10, 0] starting from the certainty with the lowest evaluation, the success percentage is obtained from the sum of the certainty with the evaluations of three or higher, and the success degree is eighty percent based on 70+10+0=80 in this example.

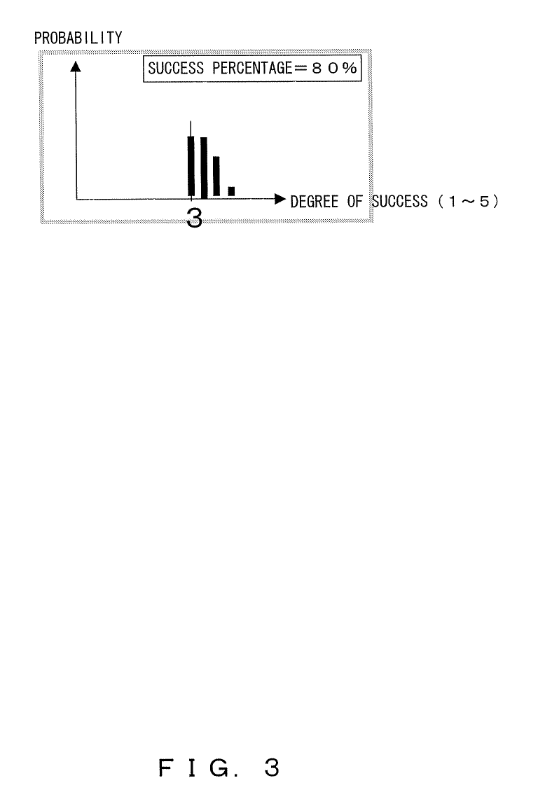

FIG. 3 shows another example of the user interface of the checklist management device 1 according to the present embodiment. The window of FIG. 3 is displayed mainly for the operator similar to FIG. 2. The horizontal axis shows the evaluation value, and the vertical axis shows the certainty. On the window, the success percentage is also displayed on the right upper part. For example, it is also possible that when the user presses a button (not shown in FIG. 3), this window showed in FIG. 2 is displayed.

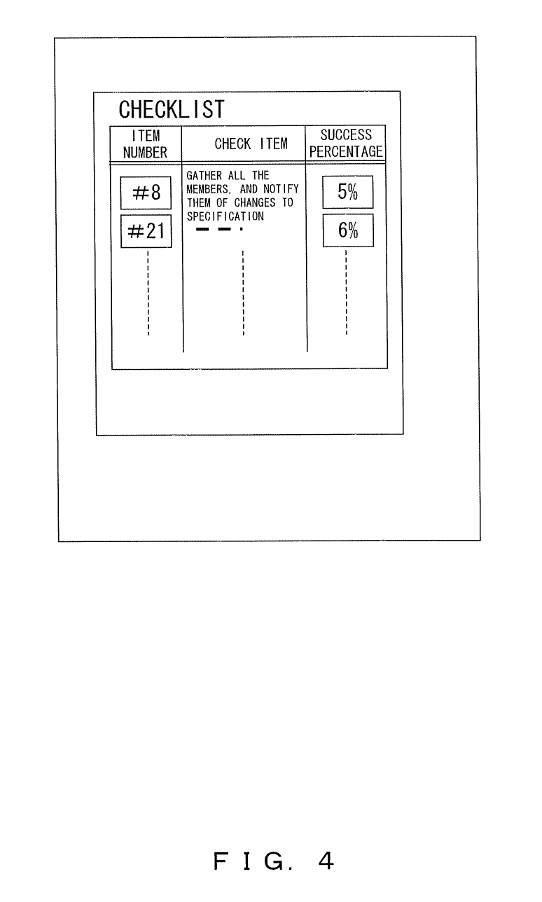

FIG. 4 shows a still another example of the user interface of the checklist management device 1 according to the present embodiment. The window in FIG. 4 is an example of the window shown to a person who manages the checklist and who is responsible for the maintenance such as deleting or the like of unnecessary check items, for example.

In the FIG. 4 window, check items 61 included in the checklist are listed in an influence display section 62 in the order starting from the item with the least influence to the greatest. The influence specifies how much each check item contributes to the evaluation, as explained in FIG. 1. The smaller the influence of the check item is, the less the item contributes to the improvement of the evaluation when the item is conducted. For example, as shown in the figure, it is possible to present to the person responsible for the maintenance of the checklist information that can serve as an index when deleting unnecessary check items by displaying the check items in the order from the item with the lowest influence.

Here, the above certainties (and success percentage) are obtained by using a conventional learning machine based on the past data accumulated in the attribute result accumulation unit 3 of the checklist management device 1. It is desirable to use Support Vector Machine (referred to as SVM hereinafter). The SVM learns of the relationship between an attribute and a result from data specifying the relationship between the attribute and the result thereof, patterns them, and then obtains a discriminant function f for obtaining the result corresponding to the attribute when an attribute x which is an input vector is given. The discriminant function f is a non-linear function generally, and is a function by which it is possible to discriminate one of two results on the basis of the value of f (x) obtained by assigning the attribute x to the discriminant function f.

By using the above technique, the discriminant function can be obtained, which specifies the relationship between the input vector (attribute) and the evaluation (result) constituted by a combination of the conduct state for each item in the checklist. In the embodiment, the evaluation of five grades is given. Accordingly, the discriminant function f_i (i=1, 2, . . . , 5) is obtained for each evaluation value by using the past data. By using the obtained discriminant function f_i, the evaluation of the attribute x which is input newly is calculated.

When the evaluation value corresponding to the input attribute is obtained using the discriminant function, the success percentage can be obtained from the evaluation value and the certainty distribution. The priority is obtained regarding the check items that are not conducted based on the success percentage obtained about the attribute x′ in which one of the conduct state information is rewritten from “0” to “1”. The success percentage about the attributex″, which corresponds to the case that only one of the check items included in the checklist is conducted, is obtained. And the influence is calculated based on the success percentage which obtained from the attribute x″.

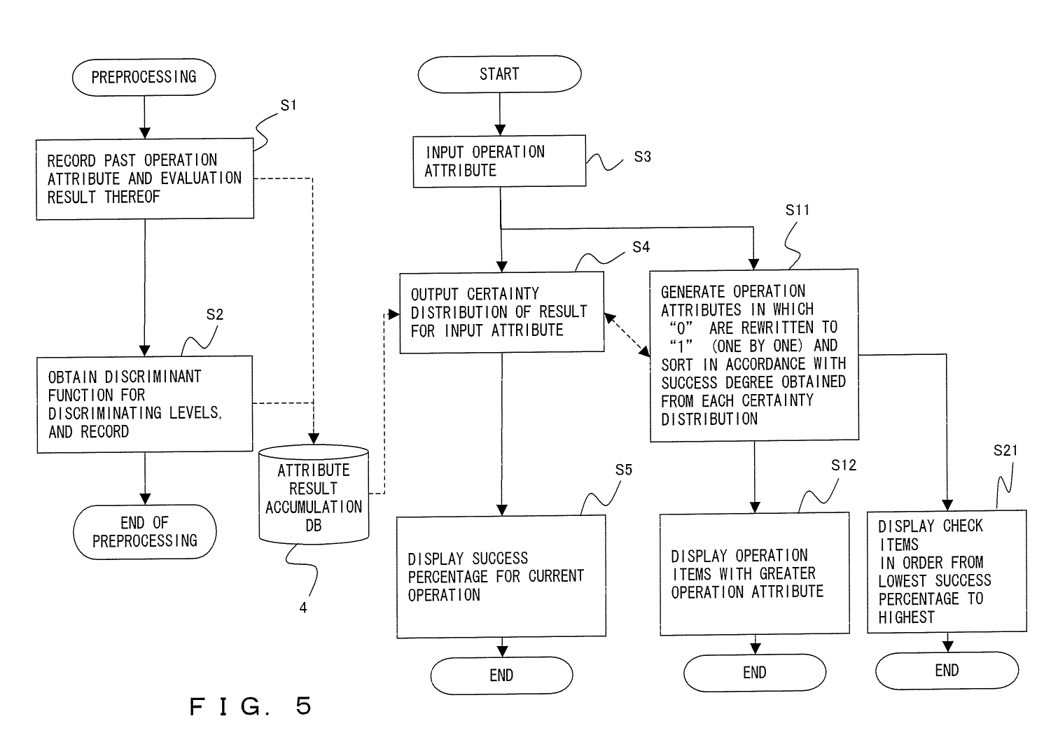

FIG. 5 is a flowchart showing the basic operations of the checklist management device 1 according to the present embodiment. Hereinbelow, a method of obtaining various information which the checklist management device 1 according to the present embodiment can present to the user is explained specifically by referring to the respective flowcharts.

As a preprocessing for executing the processes according to the present embodiment as shown in FIG. 5, in a step S1, the attribute result accumulation unit 4 (DB (Data Base)) accumulates the past operation attribute and the data of the evaluation result thereof The above discriminant function f_i (i=1, 2, . . . , 5) is obtained based on the accumulated data in order to be stored in the attribute result accumulation unit 3 and the like.

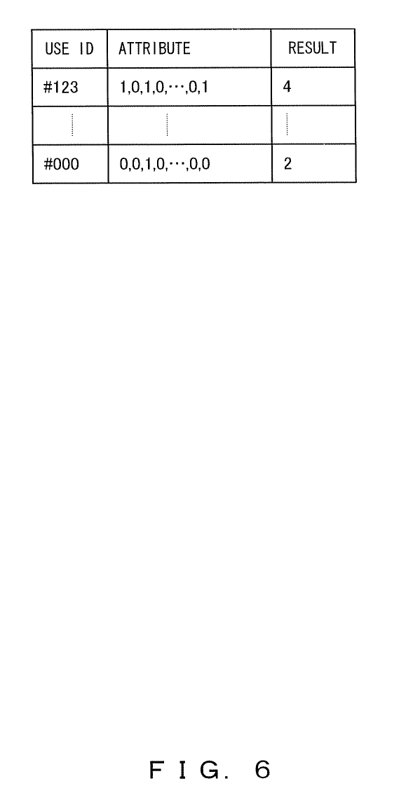

FIG. 6 shows data stored in the attribute result accumulation unit 3. The use ID is assigned to each operator. As the attribute information, “1” or “0” is stored for each item respectively when the item is conducted and when the item is not conducted. The result information is expressed in five grades, from one to five, and is input on the basis of the subject of the operator in the embodiments.

The flowchart of FIG. 5 is again explained. In a step S3, when the operator inputs the operation attribute, the processes according to the present embodiment start. The attributes newly input are expressed as vectors (1, 0, 1, 0, . . . , 0, 1; ?) , where the “?” after “;” means that the evaluation value of the result is not obtained yet.

First, a method of calculating the success percentage is explained. The process proceeds from the step S3 to the step S4, and the evaluation and the certainty distribution of the evaluation are obtained for the input attribute. Here, in order to obtain the evaluation, data concerning the past attribute and its result and the discriminant function stored in the steps S1 and S2 are used. It is assumed that the obtained certainty distributions are respectively [5, 15, 70, 10, 0] regarding the evaluation values of one to five. In a step S5, the sum of values of evaluations, which are equal to or greater than the prescribed threshold value, is obtained, the obtained value is output and displayed as the success degree, and the process then terminates.

In the process of calculating the priority, the process proceeds from the above step S3 to the step S1. The certainty distribution corresponding to the attribute in the case if the conduct state information of a certain item is changed into conducted regarding the item which is not conducted, and the success percentage corresponding to the certainty distribution are obtained. The relationship between the item number with the high success percentage and the success percentage assumes that the result of (7^{th} item: 86%, 32^{nd} item: 82% . . . ) is obtained, for example. In a step S12, the priorities are assigned to the check items in the order from the item obtaining the highest success percentage. Regarding the check items with the greater order, the priority order is output and displayed in the window shown in FIG. 1, and the process then terminates.

In the process of calculating the influence, the process proceeds from the above step S3 to a step S21 and the success percentage when only one of all the check items included in the checklist is conducted is obtained. The order of the check items is ordered from the items with the lower order using the obtained success percentage as the influence to the highest. It is assumed that by changing the order, for example, the result of (8^{th} item: 5%, 21^{st} item: 6% . . . ) is obtained as the relationship between the item number and the influence. The obtained result is output and displayed as shown in FIG. 3, and the process then terminates.

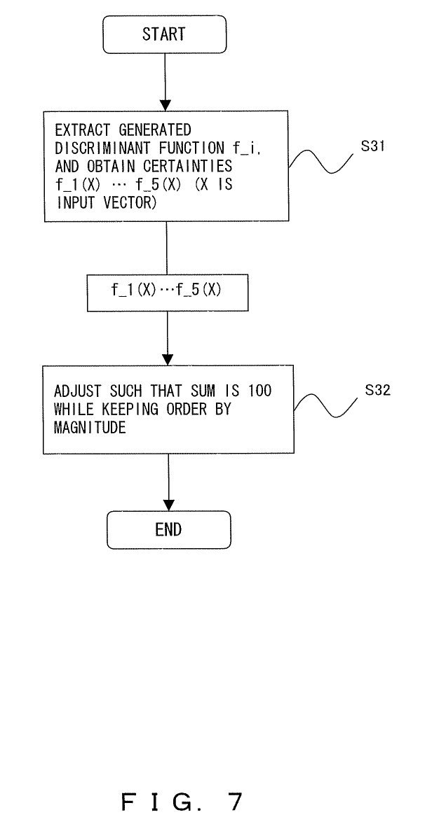

In the process of obtaining the success percentage, the priority and the influence is explained in more detail. FIG. 7 is a flowchart showing the process for obtaining the certainty distribution. The processes shown in FIG. 7 correspond to the process of the step S4 of FIG. 5.

First, in a step S31, the discriminant function f_i is extracted from a database of the attribute result accumulation unit 3 or the like and the certainties f_{—}1(x), f_{—}2(x), f_{—}5(x) corresponding to the respective levels (evaluation values) are obtained with the attribute x input by the operator as an input vector. In a step S32, adjustment (normalization) is performed so that the sum becomes 100 without changing the order of the certainties f_i (x) corresponding to the respective levels based on the magnitudes because the inequality of [certainty−∞≦f_i(x)≦+∞] is satisfied generally. Specifically, the certainty distribution normalized by the formulas (1) and (2) below is obtained. The certainty of the evaluation value i (i=1, 2, . . . , 5) is obtained by multiplying one hundred by the value adjusted to satisfy 0≦yi≦1, and weighting the obtained value.

$$\begin{matrix}[ Formula 1 ] & \\ {y}_{i} = \frac{1}{1 + exp ( - {f}_{i} ( x ) )} & ( 1 ) \\ [ Formula 2 ] & \\ \frac{{y}_{i}}{{\sum }_{i = 1}^{5} {y}_{i}} \times 100 & ( 2 )\end{matrix}$$

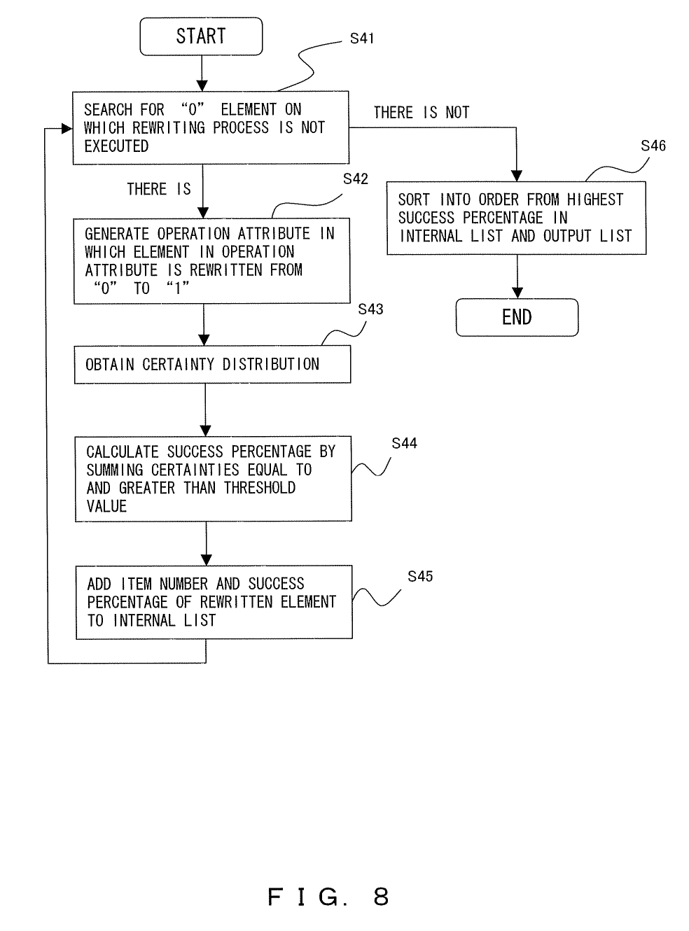

FIG. 8 is a flowchart showing processes of obtaining the priority. The processes shown in FIG. 8 correspond to the process of the step S11 of FIG. 5.

First in step S41, a search is performed to find if there is an item that has not had its priority obtained among the check items which are not conducted. When there is the item that did not have its priority calculated, among the check items that are not conducted, the process proceeds to a step S42. The operation attribute is generated, where a value is rewritten from “0” indicating that the item is not conducted, to “1” expressing that the target check item is conducted in the step S42. Then, in a step S43, the certainty distribution corresponding to the operation attribute in which the value is rewritten by the process similar to that of FIG. 7. In a step S44, the sum of the certainties which are equal to or greater than a prescribed threshold value (evaluation value “3” in the above example) and the success percentage is obtained.

In a step S45, the success percentage calculated by the processes from the step S42 to the step S44 and the item numbers thereof are stored in an internal list provided in the work area of the checklist management device 1, and the process then returns to the step S41. Thereafter, the same processes are repeated until the process in which the success percentages are calculated and the calculated success percentages are stored regarding all the items which are not conducted, in a similar manner.

When the success percentages are obtained regarding all the items which are not conducted, the process proceeds to a step S46. Then, in the step S46, the above internal list is referred to, the items are sorted into the order from the highest success degree to the lowest, the priorities of the items higher than a prescribed order are output and displayed, and the process then terminates. In an example of FIG. 2, the orders of check items with the second highest success degree and higher are displayed.

Also, in the embodiment, the success percentage is calculated based on the attribute input to the checklist management device 1. However, the scope of the present invention is not limited to this configuration. For example, it is also possible to calculate and display the success percentage in the case and the like that the operation item with the highest priority is conducted.

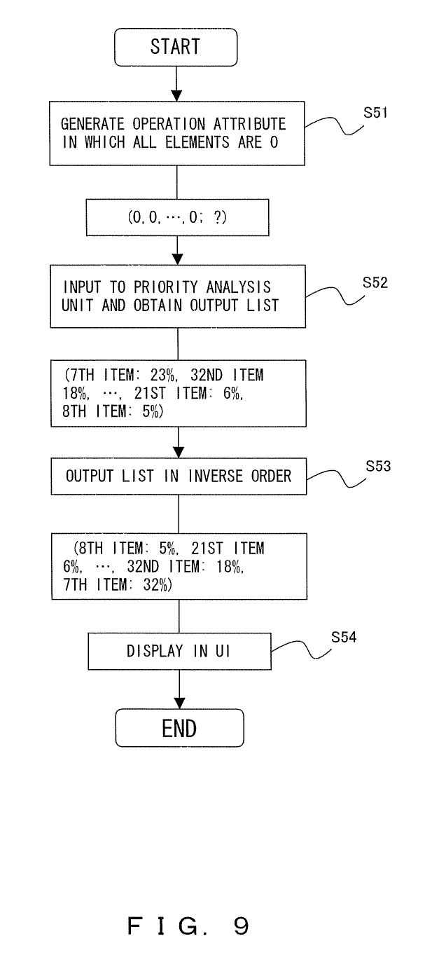

FIG. 9 is a flowchart showing the processes of obtaining the influence. The processes shown in FIG. 9 correspond to the process of the step S21 of FIG. 5.

First, in step S51, an attribute in which all the elements in the vector specifying the operation attribute are “0” (not conducted) is generated. In step S52, the obtained attribute where all the elements are “0” is input to the above priority analysis unit and the success percentage of each check item is obtained. In other words, a success percentage among a plurality of the check items included in the checklist, only the respective items that are “conducted” is obtained. In a step S53, the item numbers are sorted into the order from the lowest success percentage to the highest. In a step S54, the result of the sort is displayed in the user interface as shown in FIG. 4, and the process terminates.

As explained above by the checklist management device 1 according to the present embodiment, the relationship between the attribute and the result is patterned by the learning machine using the information about the attribute specifying the conduct state of the past check item and the result thereof. It is possible to suitably present information necessary for the operating user by using the checklist and for the person who manages the check items in the checklist for the maintenance, responding to the newly input attributes, based on the patterned relationship between the attribute and the result.

For example, the check items that should be conducted preferentially can be presented to the operator. Alternatively, it is possible to present to the operator the estimated probability of success when the conduct state is input to the checklist management device 1 based on the input operation attribute. Because these priority and the probability of success are based on the relationship between the attribute and the result obtained by the learning machine such as the SVM or the like, an objective index is provided, which does not depend on the subject of the checklist user such as the operator.

Also, for the check items that do not improve the success percentage (probability of success) even when they are conducted among the check items included in the checklist, the above influence is calculated and the calculated values can be presented to the person responsible for the maintenance in the order from the smallest value. The objective index is presented by using the SVM similarly to the cases of presenting the priority and the success probability. Accordingly, it is possible to present information which has high availability when the person who is responsible for the maintenance determines whether a check item is necessary or not, for example.

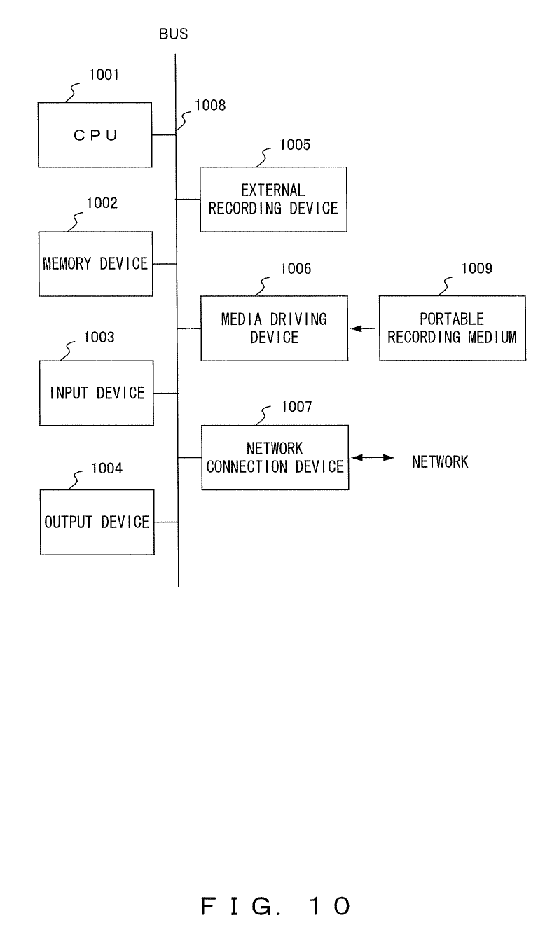

The checklist management device 1 of FIG. 1 can be configured by using, for example, an information processing device (computer) as shown in FIG. 10. The information processing device of FIG. 10 comprises a CPU (Central Processing Unit) 1001, a memory device 1002, an input device 1003, an output device 1004, an external recording device 1005, a media driving device 1006, and a network connection device 1007, which are connected to one another via a bus 1008.

The memory device 1002 include, for example, ROM (Read Only Memory), RAM (Random Access Memory) and the like, and the memory device 1002 stores a program and data used for processing. The CPU 1001 executes necessary processes by executing the program stored in the memory device 1002.

The attribute result accumulation unit 3 of FIG. 1 corresponds to the memory device 1002. The attribute result input unit 2, the attribute input unit 4, the certainty generation unit 5, the certainty display unit 6, the priority analysis unit 7, the priority display unit 8, the influence analysis unit 9, and the influence display unit 10 correspond to the functions realized by executing the program stored in the memory device 1002.

The input device 1003 is, for example, a keyboard, a pointing device, a touch panel or the like, and is used by the user such as the operator, the person responsible for the maintenance and the like for inputting instruction and information. The output device 1004 is, for example, a display device, a printer, a speaker system and the like, and is used for outputting the checklist, and process results such as the priority, the success percentage, the influence and the like.

The external recording device 1005 is, for example, a magnetic disk device, an optical disk device, a magneto-optical disk device, a tape device or the like. The information processing device stores the above program and data in the external recording device 1005, and uses them by loading them to the memory device 1002 as necessary.

The media driving device 1006 drives a portable recording medium 1009 and accesses the recorded content of the portable recording medium 1009. The portable recording medium 1009 is an arbitrary computer readable recording medium such as a memory card, a flexible disk, a CD-ROM (Compact Disk Read Only Memory), an optical disk, a magneto-optical disk, or the like. The user of the checklist management device 1 stores the above program and data in this portable recording medium 1009 and uses them by loading them to the memory device 1002 as necessary.

The network connection device 1007 is connected to an arbitrary communication network such as a LAN (Local Area Network), the Internet, or the like, and converts data used for communications. The information processing device receives the above program and data from an external device via the network connection device 1007 and loads them to the memory device 1002 in order to use them.

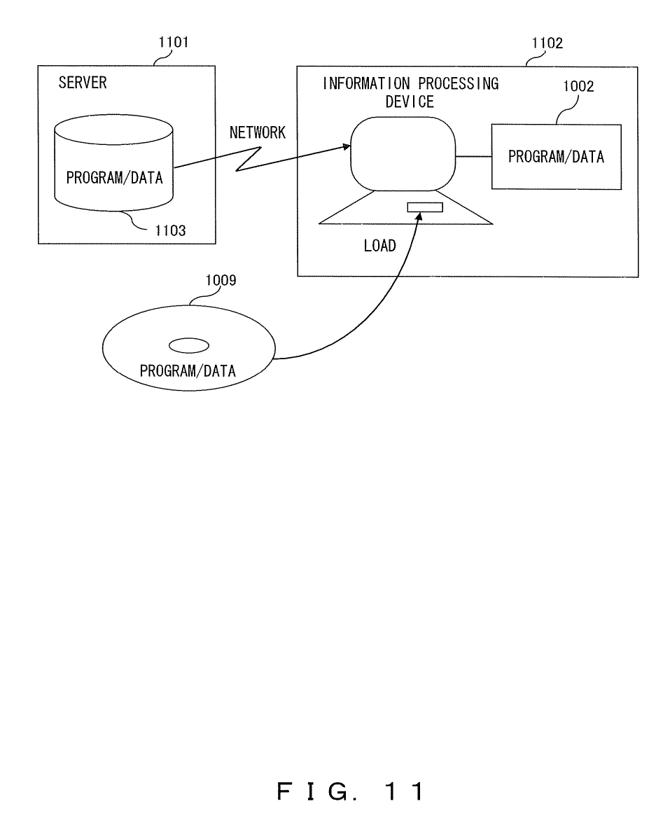

FIG. 11 shows the computer readable recording medium that can provide the program and data to the information processing device of FIG. 10. The program and data stored in the portable recording medium 1009 and in a database 1103 of a server 1101 are loaded to the memory device 1002 of the information processing device 1102. The server 1101 generates carrier signals for carrying the program and data, and transmits them to the information processing device 1102 via an arbitrary transmission medium on the network. The CPU 1001 executes the above program using the above data, and performs necessary processes.

What is claimed is:

1. A recording medium causing a computer to execute a checklist management program form an aging a checklist including a plurality of operation items which are to be checked comprising:
generating attribute information specifying whether or not the operation item is conducted for each of the operation items;
obtaining frequency distribution about an evaluation value corresponding to the generated attribute information based on a relationship which is previously prepared between the attribute information and the evaluation value corresponding to the attribute information; and
setting an evaluation degree corresponding to the generated attribute information based on a frequency corresponding to an evaluation value which is equal to or greater than a prescribed threshold value in the frequency distribution, wherein:
the generated attribute information is comprised of first attribute information obtained from setting one of the operation items, which are not conducted among input attribute information, to be conducted; and
an evaluation degree obtained for the first attribute information is set as a priority specifying a degree with which the operation item that is not conducted should be conducted preferentially.

2. The recording medium according to claim 1, further comprising:
obtaining the priority for each of the operation items which are not conducted; and
outputting and displaying the priorities regarding a prescribed number of operation items in order from the operation items with the highest priority.

3. The recording medium according to claim 1, further comprising:
setting the evaluation degree obtained for input attribute information as a success degree specifying a degree that an operation succeeds.

4. The recording medium according to claim 3, further comprising:
obtaining a success degree corresponding to a case when it is set that the operation item with the highest priority is conducted regarding the input attribute information.

5. The recording medium according to claim 1, further comprising:
selecting one of the plurality of the operation items as a selected operation item;
generating second attribute information by using a setting that only the selected operation item is conducted and other operation items are not conducted; and
setting the evaluation degree obtained for the second attribute information as influence specifying a degree that the selected operation item contributes to a success of an operation.

6. The recording medium according to claim 5, further comprising:
obtaining the influence for each of the plurality of operation items; and
outputting and displaying the influence of each operation item.

7. The recording medium according to claim 1, wherein:
the relationship that is previously prepared between the attribute information and the evaluation value is obtained by increasingly accumulating the attribute information and the evaluation values corresponding to the attribute information each time the checklist is used, and learning the relationship between the attribute information and the evaluation value corresponding to the attribute information which are accumulated.

8. The recording medium according to claim 7, wherein:
a process of learning is executed by using a support vector machine.

9. A checklist management device for managing a checklist including a plurality of operation items which are to be checked, comprising:
generation unit for generating attribute information specifying whether or not the operation item is conducted for each of the operation items;
calculation unit for obtaining frequency distribution about an evaluation value corresponding to the generated attribute information based on a relationship which is previously prepared between the attribute information and the evaluation value corresponding to the attribute information; and
setting unit for setting an evaluation degree corresponding to the generated attribute information based on a frequency corresponding to an evaluation value which is equal to or greater than a prescribed threshold value in the frequency distribution, wherein:
the attribute information generated by the generation unit is comprised of first attribute information obtained from setting one of the operation items, which are not conducted among input attribute information, to be conducted; and
an evaluation degree obtained for the first attribute information is set as a priority specifying a degree with which the operation item that is not conducted should be conducted preferentially.

10. A checklist management method for managing a checklist including a plurality of operation items which are to be checked, comprising:
generating attribute information specifying whether or not the operation item is conducted for each of the operation items;
obtaining frequency distribution about an evaluation value corresponding to the generated attribute information based on a relationship which is previously prepared between the attribute information and the evaluation value corresponding to the attribute information; and
setting an evaluation degree corresponding to the generated attribute information based on a frequency corresponding to an evaluation value, which is equal to or greater than a prescribed threshold value in the frequency distribution, wherein:
the generated attribute information comprises first attribute information obtained from setting one of the operation items, that are not conducted among input attribute information, to be conducted; and
an evaluation degree obtained for the first attribute information is set as a priority specifying a degree with which the operation item that is not conducted should be conducted preferentially.
